(19) United States
(12) Patent Application Publication
(10) Pub. No.: US 2006/0182236 A1
(43) Pub. Date: Aug. 17, 2006

(54) Speech conversion for text messaging

(75) Inventor: Rohit Kapoor, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/060,045

(22) Filed: Feb. 17, 2005

(51) Int. Cl. H04M 11/00

(52) U.S. Cl. 379/88.14

(57) ABSTRACT

Some embodiments provide conversion of an audio signal to text by a portable device, and transmission of the text from a portable device using a text messaging service. According to some aspects, an analog audio signal is received, the analog audio signal is converted to text, and the text is transmitted from the device using a text messaging service.

### BACKGROUND

1. Field

Embodiments may relate generally to text messaging. More particularly, some embodiments are concerned with the conversion of speech to text and the transmission of the text from a device.

2. Description

Text messaging has emerged as a popular form of communication. Currently, more than six trillion text messages are transmitted annually. Text messages may be transmitted using an Instant Messaging (IM) protocol, a Short Message Service (SMS) protocol, or other conventional text messaging protocols.

In one text messaging scenario, a user inputs text into a cellular telephone using a keypad and operates the cellular telephone to transmit the text to a remote user. The cellular telephone uses a text messaging service to transmit the text to the remote user. The message is received by a cellular telephone of the remote user, who then operates the cellular telephone to display the text message.

Entry of the text using the keypad can be difficult and time-consuming. These deficiencies may discourage the use of text messaging for certain people and/or in certain situations. An improved text messaging system is therefore desired.

### SUMMARY

Some embodiments provide a portable device including a converter and a text messager. The converter may be operable to convert an audio signal to text, and the text messager may transmit the text from the portable device using a text messaging service. In some aspects, the audio signal is an analog audio signal, and the portable device includes an audio input device to receive the analog audio signal.

Embodiments may also provide a system, method, program code and/or means to convert an audio signal to text, and to transmit the text from the portable device using a text messaging service. According to some aspects, conversion of the audio signal to text includes reception of a first audio signal representing a first letter, reception of a second audio signal representing a second letter, and generation of the text based on the first letter and the second letter. Conversion of the audio signal to text may also include identification of the first audio signal as representing the first letter, display of the first letter before receiving the second audio signal, identification of the second audio signal as representing the second letter, and display of the second letter.

According to some embodiments, a device includes an audio input device to receive an analog audio signal, a converter to convert the analog audio signal to text, and a text messager to transmit the text from the device using a text messaging service. Such a device may also include a telephone phone line interface to receive a telephone line, where the text is to be transmitted over the telephone line.

Some aspects may include receipt of an analog audio signal, conversion of the analog audio signal to text, and transmission of the text from the device using a text messaging service. Conversion of the audio signal to text may include, in some aspects, receipt of a first audio signal representing a first letter, receipt of a second audio signal representing a second letter, and generation of the text based on the first letter and the second letter.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram of a system according to some embodiments;

FIG. 2 is a flow diagram of a process according to some embodiments;

FIG. 3 is an outward view of a telephone according to some embodiments;

FIG. 4 is a block diagram of the internal architecture of a telephone according to some embodiments;

FIG. 5 is a block diagram of a telephone operating system according to some embodiments;

FIG. 6 is a block diagram of the software architecture of a telephone according to some embodiments;

FIG. 7 is a flow diagram of a process according to some embodiments;

FIG. 8 is an outward view of a telephone according to some embodiments;

FIG. 9 is an outward view of a telephone according to some embodiments;

FIG. 10 is an outward view of a telephone according to some embodiments;

FIG. 11 is an outward view of a telephone according to some embodiments;

FIG. 12 is a diagram of a system architecture according to some embodiments; and

FIG. 13 is an outward view of a telephone according to some embodiments.

### DETAILED DESCRIPTION

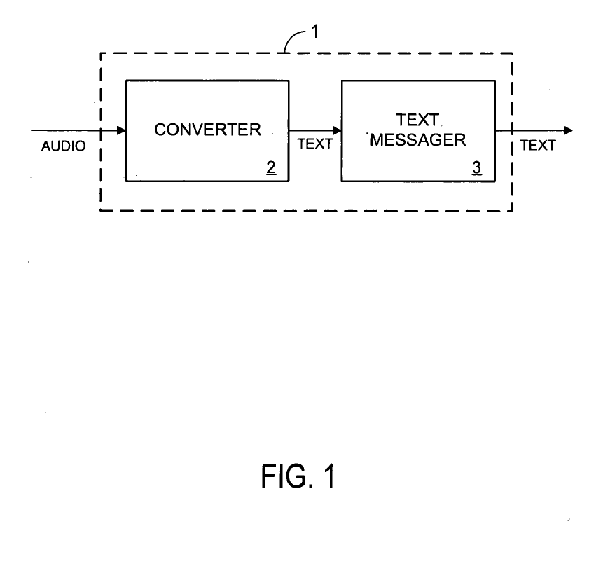

FIG. 1 is a block diagram of device 1 according to some embodiments. Device 1 may convert an audio signal to text, and transmit the text using a text messaging service. In some embodiments, the audio signal is an analog audio signal received by device 1.

Device 1 may comprise a portable device or a fixed device, the latter including but not limited to a “land line” telephone. Examples of portable devices include cellular telephones, personal digital assistants (PDAs), digital media players, digital cameras, wireless email devices, and any other device for transmitting text messages that is or becomes known.

Device 1 includes converter 2 and text messager 3. Converter 2 may receive an audio signal from a source external to device 1. The audio signal may comprise an analog audio signal. Converter 2 converts the audio signal to text, which is in turn received by text messager 3. Text messager 3 uses a text messaging service to transmit the text from device 1.

The text messaging service may comprise any currently- or hereafter-known text messaging service. Conventional examples include IM, SMS, Multimedia Message Service (MMS), Enhanced Message Service (EMS), and electronic mail. The message may be transmitted to any software and/or hardware client of the service used to transmit the text.

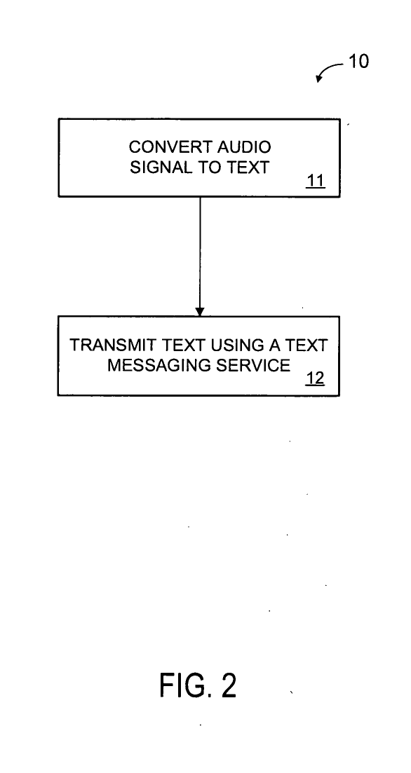

FIG. 2 is a flow diagram of process 10 according to some embodiments. Process 10 may be executed by device 1 using any suitable hardware and/or software arrangement.

Initially, an audio signal is converted to text at 11. The audio signal may encode speech representing one or more letters, numbers, words, punctuation marks, or any other elements that may be represented in text. According to some embodiments, the audio signal is an analog audio signal received by an analog audio input device such as a microphone of device 1.

Conversion of the audio signal to text may proceed according to any audio-to-text conversion that is or becomes known. In some embodiments, device 1 stores audio files representing a discrete set of words, letters, numbers, punctuation, or other audio. The audio signal is compared against the stored audio files to determine whether one of the audio files corresponds to the audio signal. Such a correspondence may be determined using any currently- or hereafter-known system of comparing audio data. For example, some conventional cellular telephones use a similar system to provide voice-activated dialing.

Once a corresponding audio file is identified, text associated with the audio file may be determined. The text may be associated with the audio file via a database record, via codes embedded in the audio file, or in any other manner. The text is then passed to text messager 3.

Text messager 3 transmits the text using any currently- or hereafter-known text messaging service at 12. As mentioned above, text messaging services include but are not limited to IM, SMS, EMS, MMS and electronic mail. The text may be transmitted to any type of system that is capable of receiving a text message that is sent via the utilized text messaging protocol.

Some embodiments of the FIG. 1 system and/or the FIG. 2 system provide more efficient text messaging than previously available.

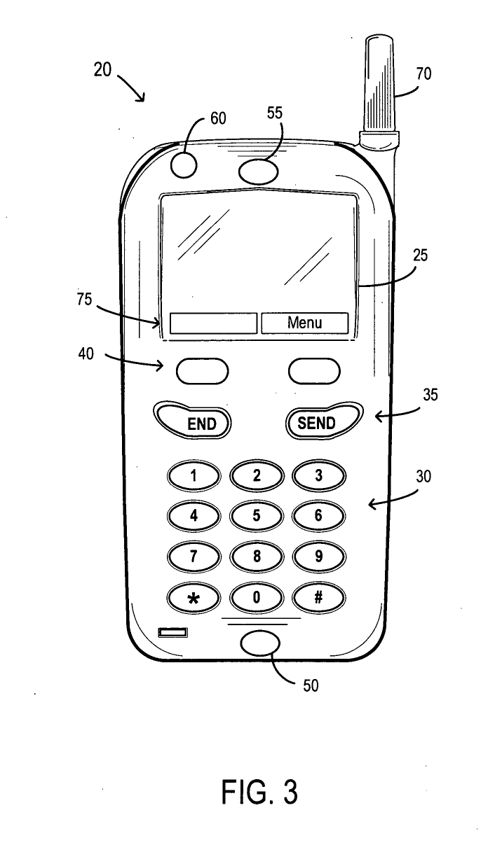

FIG. 3 is a schematic front elevation view of portable cellular telephone 20. Cellular telephone 20 may comprise device 1 of FIG. 1 and/or may execute process 10 according to some embodiments. Cellular telephone 20 may include conventional components, and may include program code for performing certain functions described herein. Embodiments may differ in part or in whole from cellular telephone 20.

Cellular telephone 20 may be compatible with one or more cellular communication protocols. Examples of such protocols include but are not limited to Time Division Multiple Access (TDMA) (e.g., GSM, D-AMPS), Code Division Multiple Access (CDMA), and CDMAOne (e.g., PCS). As described above, some embodiments operate in conjunction with non-cellular and/or non-portable devices.

Cellular telephone 20 includes housing 22, display 25, keypad 30, fixed function keys 35, variable function keys 40, microphone 50, speaker 55, power button 60 and antenna 70. Display 25 is mounted at least partially within housing 22 and displays a user interface for accessing the functionality of telephone 20. Alphanumeric keypad 30 is laid out like a conventional telephone dialing keypad, and fixed function keys 35 are used, respectively, to initiate a communication and to terminate a communication. Variable function keys 40 provide functions that vary in accordance with function labels 75 displayed on display 24 above keys 40.

Microphone 50 receives audio signals which may represent speech of a user. The speech may comprise analog audio signals representing letters, numbers, words, punctuation, and other elements that may be converted to text. The audio signals may comprise commands for operating telephone 20.

Speaker 55 emits audio signals from telephone 20. The audio signals may comprise ring tones, beeps and other tones used during operation of telephone 20, and/or speech or other audio signals received from another device such as another telephone. Speaker 55 may also emit audio signals representing speech or other sounds received by microphone 50.

Power button 60 may be used to turn cellular telephone 20 on and off. Antenna 70 may receive and transmit radio frequency signals from and to a cellular telephone network. Antenna 70 may be configured to transmit and receive any types of signals that comply with the communication protocol of the communication network in which telephone 20 is employed.

In some examples of operation, a user operates keypad 30 and/or variable function keys 40 to place telephone 20 into a speech-to-text message mode. The user then speaks and thereby transmits an audio signal that is received by microphone 50. The audio signal is converted to text, which is displayed on display 25. The user may then select a recipient using keypad 30 and/or variable function keys 40, and transmit the text to the recipient using an appropriate text messaging service by pressing “Send” function key 35.

According to some embodiments, the user may speak a series of letters (e.g., “H”, “E”, “L”, “L”, “O”) that are received as separate analog signals by microphone 50. The signals may be individually converted to text that is displayed on display 25. In this regard, telephone 20 may be capable of converting audio signals to only a discrete set of text, which may reduce an amount of memory and/or processing power that would otherwise be required. Such a set of text may comprise only letters, only letters and numbers, only letters and punctuation, only letters, numbers, and punctuation, only letters, punctuation, and a small set of words, only letters, numbers, punctuation, and a small set of words, or any other desired set of text.

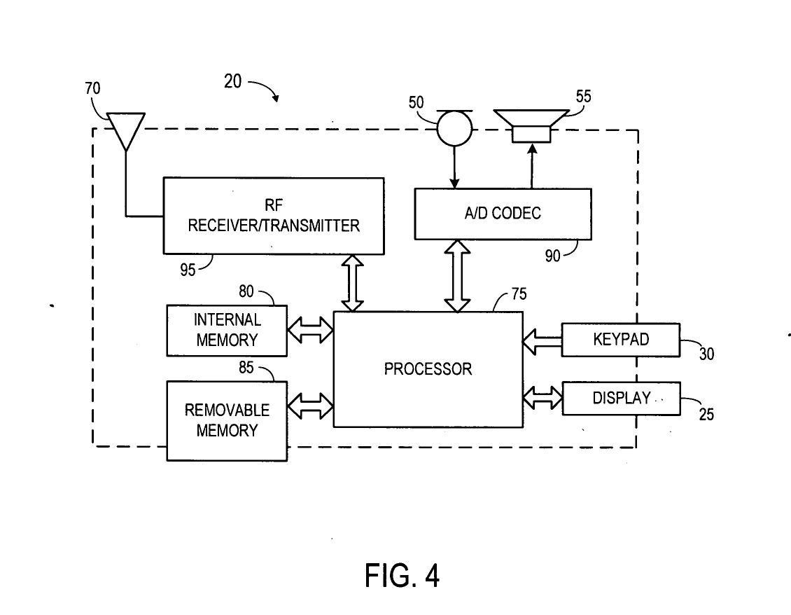

FIG. 4 is a block diagram of the internal architecture of cellular telephone 20 according to some embodiments. As shown, cellular telephone 20 includes processor 75, which may be a conventional microprocessor, microcontroller and/or digital signal processor (DSP) or other control circuit conventionally provided in a cellular telephone. Processor 75 is shown in communication with keypad 30 and display 25 for control thereof.

Also included in the cellular telephone 20 are internal memory 80 and removable memory 85. Internal memory 80 may include one or more of ROM (read only memory), RAM (random access memory, e.g., static RAM), and flash memory. Removable memory 85 may comprise a flash memory, a Subscriber Identity Module (SIM) card or any other removable memory that is or becomes known. Cellular telephone 20 may therefore be equipped with an interface for physically receiving and transferring data to and from removable memory 85.

Memories 80 and 85 may store program code that is executable by processor 75 to control telephone 20. The program code may include but is not limited to operating system program code, application program code, device driver program code, and database connector program code. The program code may include code to cause telephone 20 to perform functions that are described herein.

Memories 80 and 85 may also store data used in the operation of cellular telephone 20. Such data may include phone numbers, addresses, access codes, stored audio files, text corresponding to the stored audio files, and other data. Some or all of the data may be read-only, while other of the data may be rewritable.

Analog/digital coder/decoder (A/D codec) 90 is also in communication with processor 75. A/D codec 90 may receive analog signals from microphone 50, convert the analog signals to digital signals, and pass the digital signals to processor 75. Conversely, processor 75 may transmit digital signals to A/D codec 90, which converts the digital signals to analog signals and passes the analog signals to speaker 55. Speaker 55 then emits sound based on the analog signals.

RF receiver/transmitter 95 is operatively coupled to antenna 70. RF receiver/transmitter 95 may, in accordance with conventional practices, comprise a combination of two or more different receive/transmit modules (not separately shown) that operate in accordance with mutually different radio communication protocols to provide various services for the cellular telephone 20. For example, receiver/transmitter 95 may operate in accordance with one radio communication protocol to provide conventional two-way service for cellular telephone 20, and may operate in accordance with another radio communication protocol to provide PoC service for cellular telephone 20.

Those in the art will understand that the block diagram of FIG. 4 is simplified in a number of ways. For example, all power and power management components of cellular telephone 20 are omitted from the diagram. Also, some embodiments may employ an internal architecture somewhat or completely different from that shown in FIG. 4.

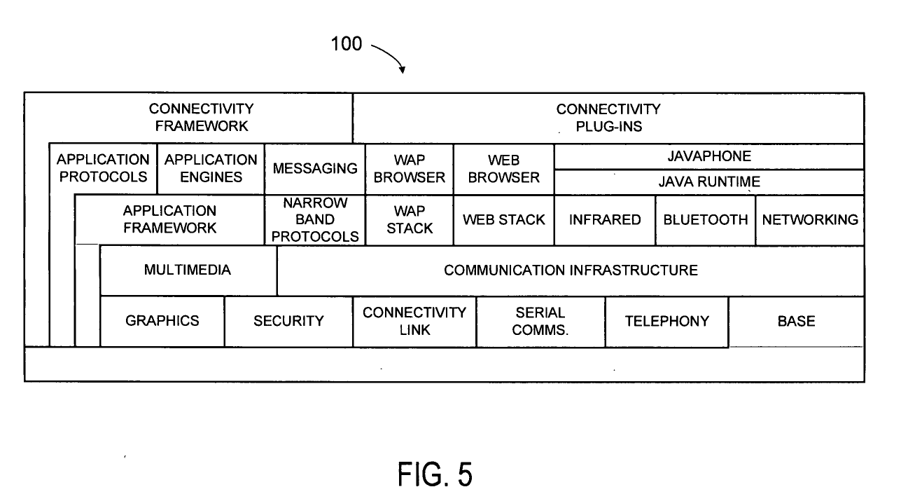

FIG. 5 is a block diagram of an operating system architecture that may be used in conjunction with some embodiments. Architecture 100 corresponds to the Symbian™ cellular telephone operating system. Any suitable operating system may be used in conjunction with some embodiments, including those not intended and/or usable with cellular telephones. Suitable operating systems according to some embodiments include but are not limited to Palm OS™, Windows CE™, and operating systems suitable for devices capable of transmitting text messages (e.g., landline telephones, PDAs, digital media players).

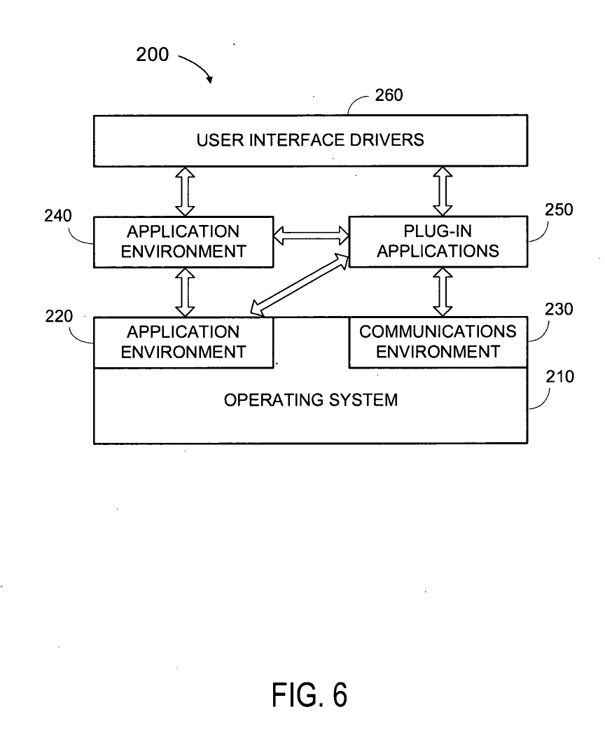

FIG. 6 is a block diagram of a general software architecture that may be used within cellular telephone 20 in conjunction with some embodiments. Architecture 200 may operate to receive an analog audio signal, to convert the audio signal to text, and to transmit the text using a text messaging service.

Architecture 200 includes operating system 210, which may comprise architecture 100 of FIG. 5. In such a case, application environment 220 and communications environment 230 may correspond, respectively, to the connectivity framework and the connectivity plug-ins of architecture 100. Generally, application environment 220 provides a platform by which another application environment 240 may interface with operating system 210. Application environment 240 may comprise a Java™ or C programming environment. As such, plug-in applications 250 may be written in Java or C for execution by cellular telephone 20. Plug-in applications 250 may also be written for the application interface provided by application environment 220.

Communications environment 230 provides plug-in applications 250 with access to the communications functionality of operating system 210. This functionality may include text messaging, Web browsing and of course telephone communication. Plug-in applications 250 may also transmit data and commands to and receive input from user interface drivers 260 for control of the user interfaces of telephone 20.

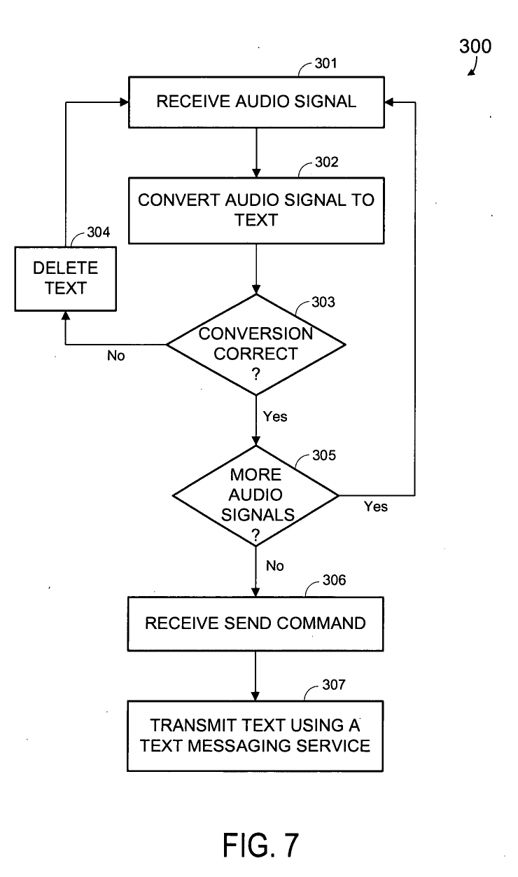

FIG. 7 is a flow diagram of process 300 according to some embodiments. Process 300 may be embodied in hardware and/or software of device 1, telephone 20, or one or more other suitable devices. In the foregoing description, process 300 will be described as if embodied in program code of one of plug-in applications 250. As described above, such program code may be executable within a multi-platform environment such as application environment 240 and/or within the environment provided by application environment 220. Process 300 may also be embodied in native program code of telephone 20.

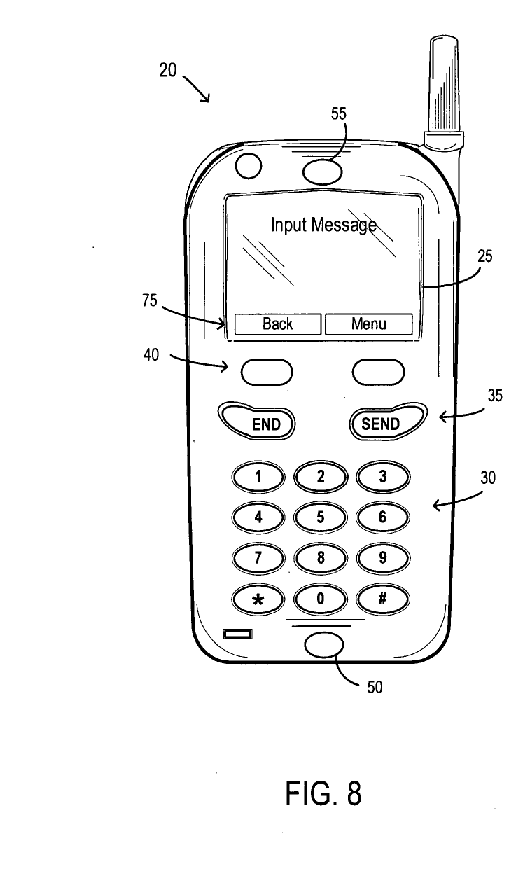

Prior to process 300, a user causes cellular telephone 20 to enter a “voice-to-text messaging” mode. For example, the user may manipulate keypad 30 and variable function keys 40 to cause display 25 to indicate that cellular telephone 20 is ready to receive a message. FIG. 8 is an outward view of telephone 20 in the desired mode according to some embodiments. Keypad 30, variable function keys 40, and display 25 are controlled in the present example by one of plug-in applications 250 when telephone 20 is in the illustrated mode.

An audio signal is then received at 301. The audio signal is received by microphone 50, and may comprise an analog signal. The audio signal may represent speech generated by a human or a machine. The speech may represent a single letter, number, or punctuation mark (i.e., space, comma, period, exclamation point, etc.). In the present example of 301, the user has spoken the letter “H” into microphone 50. According to some embodiments, the speech may represent one or more letters, numbers, punctuation marks, words, sentences, etc.

Cellular telephone may stop receiving the audio signal and flow may proceed from 301 after a pause of a particular duration is detected, after a specified amount of time, in response to user selection of one of keys 30 through 40, or based on some other event. In some embodiments, the received audio signal is converted to the digital domain by A/D codec 90 and passed from processor 75 to one or both of memories 80 and 85. The audio signal is then converted to text at 302.

Conversion of the audio signal to text may proceed by any technique that is or becomes known. According to some embodiments, memories 80 and/or 85 store audio files representing a discrete set of words, letters, numbers, punctuation, or other audio. Some examples store audio files representing only the twenty-six letters of the English alphabet, “space” and “stop” (or “period”). Other examples also store audio files representing the ten Arabic numeric digits. One or more of the audio files may be pre-recorded by a manufacturer of telephone 20 or by the user during a “learn” mode.

The received audio signal may be compared against the stored audio files to determine whether one of the audio files corresponds to the received audio signal. Such a correspondence may be determined using any currently- or hereafter-known system of comparing audio data. Text associated with the corresponding audio file is then determined. As mentioned above, the text may be associated with the audio file via a database record, via codes embedded in the audio file, or in any other manner.

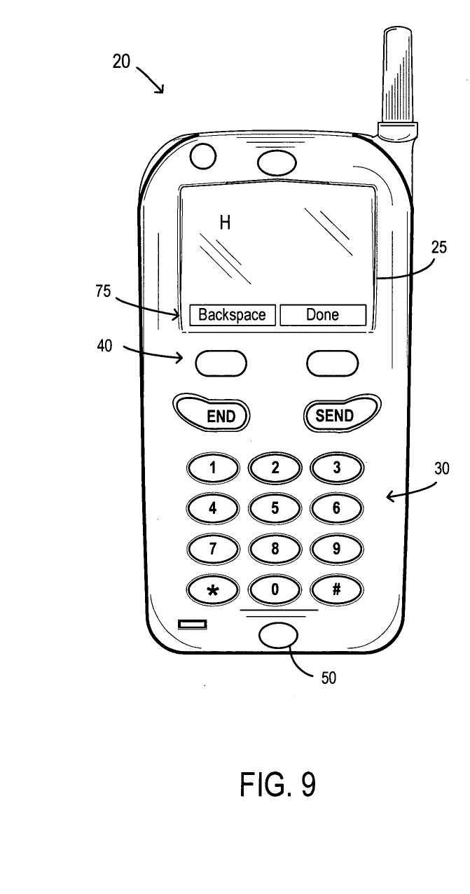

Next, at 303, it is determined whether the audio-to-text conversion was correct. FIG. 9 shows display 25 after 302. Display 25 presents the letter “H” along with new variable function key labels 75. The user may select variable function key 40 that corresponds to “Backspace” label 75 if the conversion was not correct. If so, the “H” is deleted from display 25 and flow returns to 301.

If the conversion is correct, flow proceeds to 305 to determine if more audio signals are to be received. The determination at 305 may be positive if a user does not select variable function key 40 that corresponds to “Done” label 75. Accordingly, simply speaking again into microphone 50 may cause flow to return to 301 for reception of another audio signal representing the speech in some embodiments. In other embodiments, a different user action such as a keypress or a spoken command may be required to indicate that more audio signals are to be received.

Flow may cycle between 301 and 305 as described above until display 25 displays a desired text message and it is determined that no more audio signals are to be received. Again, this determination may be based on user selection of variable function key 40 that corresponds to “Done” label 75. In some embodiments, cellular telephone 20 is capable of receiving text input via keypad 30 as well as audio signals via microphone 50 to generate a text message during 301 through 305.

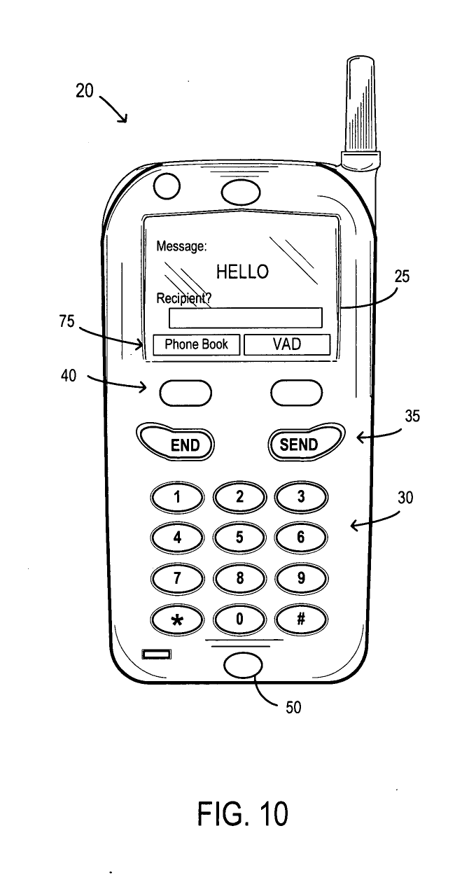

Flow continues from 305 to 306 if it is determined that no more audio signals are to be received. A command to send the text is received at 306. The command may include a telephone number or other information for identifying a recipient of the text. FIG. 10 illustrates cellular telephone 20 during some embodiments of 306.

Display 25 of FIG. 10 presents the complete text message as well as a field for entering recipient information. The information may consist of a name or a telephone number input via keypad 30. The name may correspond to a phone book entry stored in memory 80 or 85. Labels 75 indicate that keys 40 may be selected to access the phone book or to activate a voice-activated dialing feature. The send command may be received at 306 according to the voice-activated dialing protocol or in response to user selection of Send function key 35.

The text is transmitted in response to the send command at 307. The text may be transmitted using any suitable text messaging service. The text messaging service may be a service supported by operating system 210 of telephone 20 and by a recipient device. In some embodiments of 307, the text is formatted into data according to a protocol specified by the text messaging service and by any other applicable network protocols, and the data is passed to RF receiver/transmitter 95 to modulate a carrier signal. The modulated carrier signal is then transmitted by antenna 70.

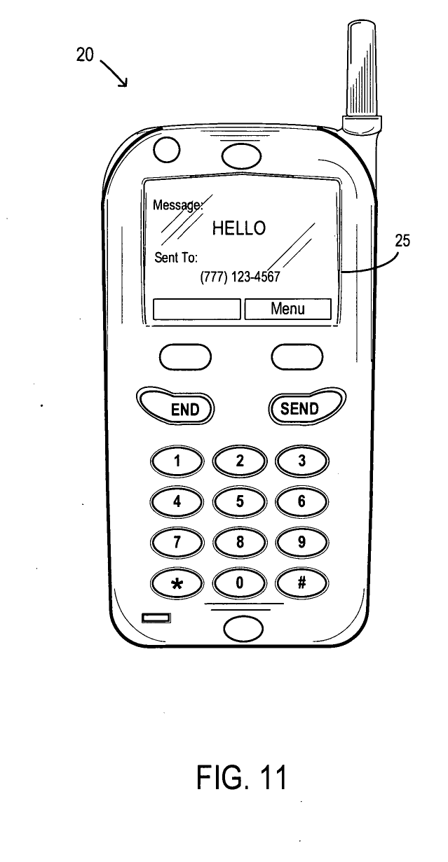

Display 25 of telephone 20 may present a confirmation message upon successful transmission of the text. FIG. 11 illustrates such a message according to some embodiments.

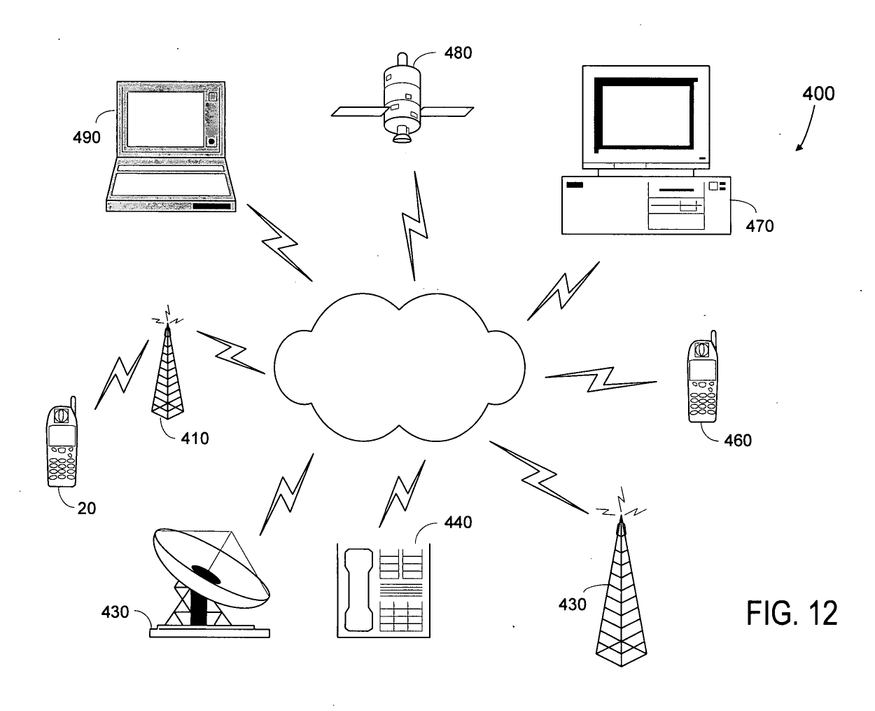

The text may pass through any number of networks, devices and protocols before reaching its recipient. FIG. 12 is a partial diagram of system 400 according to some embodiments. System 400 may be used to deliver the text from cellular telephone 20 to its recipient.

Cellular telephone 20 is shown in communication with tower 410. Tower 410 may receive the transmission directly from antenna 70, and may forward the transmission to communication network 420 according to governing protocols. Communication network 420 may include any number of devices and systems for transferring data, including but not limited to local area networks, wide area networks, telephone networks, cellular networks, fiber-optic networks, satellite networks, infra-red networks, radio frequency networks, and any other type of networks which may be used to transmit information between devices. Additionally, data may be transmitted through communication network 420 using one or more currently- or hereafter-known network protocols, including but not limited to Asynchronous Transfer Mode (ATM), Internet Protocol (IP), Hypertext Transfer Protocol (HTTP) and Wireless Application Protocol (WAP).

Devices 430 through 490 are examples of some devices that may be a part of or in communication with communication network 420. As such, devices may receive text associated with a text messaging service, either as intended recipient or as a network node for passing on message. Devices 430 through 490 include satellite transmitter/receiver 430, landline telephone 440 having a telephone line interface to receive a telephone line (e.g., a cordless phone or a corded phone), communication tower 450, cellular telephone 460, desktop computer 470, satellite 480 and laptop computer 490. Any other suitable devices may be used as a transmitting device or a receiving device in conjunction with some embodiments.

The elements of system 400 may be connected differently than as shown. For example, some or all of the elements may be connected directly to one another. Embodiments may include elements that are different from those shown. Moreover, although the illustrated communication links between the elements of system 400 appear dedicated, each of the links may be shared by other elements. Elements shown and described as coupled or in communication with each other need not be constantly exchanging data. Rather, communication may be established when necessary and severed at other times or always available but rarely used to transmit data.

It will be assumed that cellular telephone 460 is the intended recipient of the text transmitted at 307 of process 300. More particularly, cellular telephone 460 is associated with the telephone number to which the text was transmitted using the text messaging service. Cellular telephone 460 therefore may provide a client application for receiving text transmitted via the text messaging service.

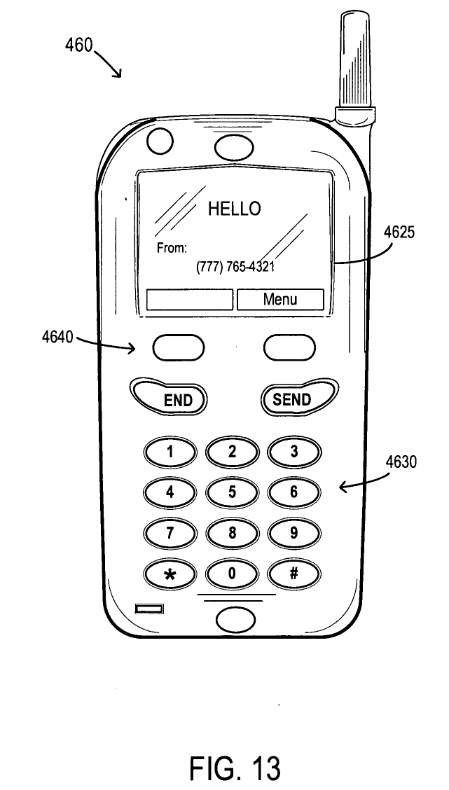

FIG. 13 shows an outward view of cellular telephone 460 after receiving the text in accordance with some embodiments. A user of cellular telephone 460 has manipulated keys 4630 and/or 4640 so as to cause the text to be displayed on display 4625. Some embodiments provide other systems for displaying text received via a text messaging service. Although a cellular telephone is shown as both a text-transmitting device and a text-receiving device in the above example, one or both of the text-transmitting device and the text-receiving device might comprise devices other than cellular telephones according to some embodiments.

The processes described herein may be embodied as program code developed using an object-oriented language that allows the modeling of complex systems with modular objects to create abstractions that are representative of real world, physical objects and their interrelationships. However, embodiments may be implemented in many different ways using a wide range of programming techniques as well as general-purpose hardware systems or dedicated controllers. In addition, in some embodiments, many, if not all, of the elements described above are optional or can be combined into single elements.

Embodiments described above are not intended to be limited to the specific form set forth herein, but are intended to cover such alternatives, modifications and equivalents as can reasonably be included within the spirit and scope of the appended claims.

What is claimed is:

1. A portable device comprising:
a converter to convert an audio signal to text; and
a text messager to transmit the text from the portable device using a text messaging service.

2. A portable device according to claim 1, wherein the audio signal is an analog audio signal, the portable device further comprising:
an audio input device to receive the analog audio signal.

3. A portable device according to claim 1, further comprising:
a text input device to receive second text,
wherein the text messager is to transmit the second text from the portable device using the text messaging service.

4. A method for a portable device, comprising:
converting an audio signal to text; and
transmitting the text from the portable device using a text messaging service.

5. A method according to claim 4, further comprising:
receiving the audio signal using a microphone of the portable device.

6. A method according to claim 4, wherein converting the audio signal to text comprises:
receiving a first audio signal representing a first letter;
receiving a second audio signal representing a second letter; and
generating the text based on the first letter and the second letter.

7. A method according to claim 6, wherein converting the audio signal to text comprises:
identifying the first audio signal as representing the first letter;
displaying the first letter before receiving the second audio signal;
identifying the second audio signal as representing the second letter; and
displaying the second letter.

8. A method according to claim 1, wherein converting the audio signal to text comprises:
converting only audio signals representing letters, numbers and punctuation to text.

9. A device comprising:
an audio input device to receive an analog audio signal;
a converter to convert the analog audio signal to text; and
a text messager to transmit the text from the device using a text messaging service.

10. A device according to claim 9, further comprising:
a text input device to receive second text,
wherein the text messager is to transmit the second text from the device using the text messaging service.

11. A device according to claim 9, further comprising:
a telephone phone line interface to receive a telephone line,
wherein the text is to be transmitted over the telephone line.

12. A method for a device, comprising:
receiving an analog audio signal;
converting the analog audio signal to text; and
transmitting the text from the device using a text messaging service.

13. A method according to claim 12, wherein converting the audio signal to text comprises:
receiving a first audio signal representing a first letter;
receiving a second audio signal representing a second letter; and
generating the text based on the first letter and the second letter.

14. A method according to claim 13, wherein converting the audio signal to text comprises:
identifying the first audio signal as representing the first letter;
displaying the first letter before receiving the second audio signal;
identifying the second audio signal as representing the second letter; and
displaying the second letter.

15. A method according to claim 12, wherein converting the audio signal to text comprises:
converting only audio signals representing letters, numbers and punctuation to text.
